(19) United States
(12) Patent Application Publication
(10) Pub. No.: US 2005/0282586 A1
(43) Pub. Date: Dec. 22, 2005

(54) Elevated antenna and mounting structure in a wireless network

(76) Inventors: Joe A. Rutherford, Fate, TX (US); Thomas A. Adcox, Nevada, TX (US)

Correspondence Address: DOCKET CLERK, P.O. DRAWER 800889, DALLAS, TX, 75380, US

(21) Appl. No.: 11/123,963

(22) Filed: May 6, 2005

Related U.S. Application Data
(60) Provisional application No. 60/581,607, filed on Jun. 22, 2004.
(60) Provisional application No. 60/661,268, filed on Mar. 11, 2005.

(51) Int. Cl. H04B 1/38

(52) U.S. Cl. 455/562.1; 455/561

(57) ABSTRACT

An antenna support structure (or base station) in a wireless network is provided that supports both an antenna for wireless communications and one or more outdoor images or pictorial messages. The antenna is mounted to the support structure and is operable for receiving and transmitting wireless signals from one or more communications devices located at a remote location allowing for broadband wireless access to the communications device. The antenna support structure also functions as a base station (or repeater/relay station) and wirelessly communicates to a backhaul network.

### CROSS REFERENCE TO RELATED APPLICATIONS

This application claims priority under 35 USC 119(e) to U.S. provisional Application Ser. No. 60/581,607, filed on Jun. 22, 2004, and to U.S. provisional Application Ser. No. 60/661,268, filed on Mar. 11, 2005, and which are incorporated herein by reference.

### TECHNICAL FIELD OF THE INVENTION

The present invention relates to an antenna and mounting system, and in particular, to an elevated antenna and mounting structure for use in a wireless network.

### BACKGROUND

Existing infrastructure and current technologies have limited the availability of broadband access in many areas, including rural areas. One of the problems causing this limited availability is the cost and development of the wireless network infrastructure, including the placement/deployment of base stations and antennas, needed to adequately service these areas.

Accordingly, there exists a need for apparatus and methods that reduce the time and costs for deployment of this infrastructure and distribution equipment for such wireless network.

### SUMMARY

In accordance with one embodiment of the present invention, there is provided an antenna mounting structure for a base station at a first location in a wireless network. The antenna mounting structure includes a structural member and a first display member having a first display surface wherein the first display surface includes a first visible message placed thereon. An antenna is further provided to operably receive and transmit wireless communications signals from a wireless communication device at a second location.

In another embodiment of the present invention, there is provided an outdoor advertisement structure having a structural member for supporting one or more other members. A first display member is mounted to the structural member, the first display member having a first surface, the first surface having an image thereon encompassing about forty square feet or greater. The structure further includes an antenna mounted to the structural member at a height above the first display member, and the antenna is further operable for receiving and transmitting wireless communications signals from a wireless communication device at another location. Electronic circuitry is coupled to the antenna for processing wireless communications signals.

In yet another embodiment of the present invention, there is provided a base station in a wireless network. The base station includes an elevated frame structure having at least one vertically extending support member and a bracing and support structure connected to the vertically extending support member. A first display member having a first display surface is connected to the bracing and support structure, wherein the first display surface includes a visible message placed thereon. An antenna support member is coupled to the elevated frame and includes a guide member and a mast member having a distal end and a proximal end. The distal end of the mast member extends upwardly and is movable from a first position to a second position relative to the guide member. The base station further includes an antenna connected to the distal end of the mast member, and is operable for receiving and transmitting wireless communications signals from a wireless communication device at a remote location. The antenna is positioned at a first height when the mast member is in the first position and at a second height when the mast member is in the second position, and wherein second height is above the first display member. Electronic circuitry is coupled to the antenna for processing wireless communications signals.

In still another embodiment of the present invention, there is provided a wireless network comprising a first base station at a first location and a second base station at a second location. Each base station includes a billboard structure having an image thereon, and an antenna mounted on the billboard structure, with the antenna operable for receiving and transmitting wireless communications signals to a communication device located with a coverage area of the respective base station. The antenna of the first base station is further operable for receiving/transmitting wireless communications from/to the second base station or another base station at another location, and the antenna of the second base station is further operable for receiving/transmitting wireless communications from/to the first base station or another base station at another location.

The present invention further provides a method, in a base station structure having an antenna mounted thereon for receiving and transmitting wireless communications signals compliant with the IEEE 802.16 standard in a wireless network, for receiving wirelessly a first communication signal from a first communications device located at a first geographic location remote from the base station structure. The method further includes transmitting wirelessly a second communication to a second communications device located at a second geographic location remote from the base station structure, the second communication signal comprising at least a portion of data from the received first communication signal. An image on a display surface mounted on the base station structure is contemporaneously displayed during communication.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is an overall block diagram of a wireless network in accordance with the present invention;

FIGS. 2A and 2B are perspective and side views, respectively, of a base station or antenna mounting structure in a of the present invention;

FIG. 3 is another embodiment of an antenna mounting structure;

FIG. 4 is a detailed diagram illustrating another embodiment of an antenna mounting structure;

FIGS. 5A and 5B are partial views illustrating another embodiment of the antenna mounting structure; and

FIGS. 6A and 6B are partial views illustrating another embodiment of the antenna mounting structure.

### DETAILED DESCRIPTION OF THE INVENTION

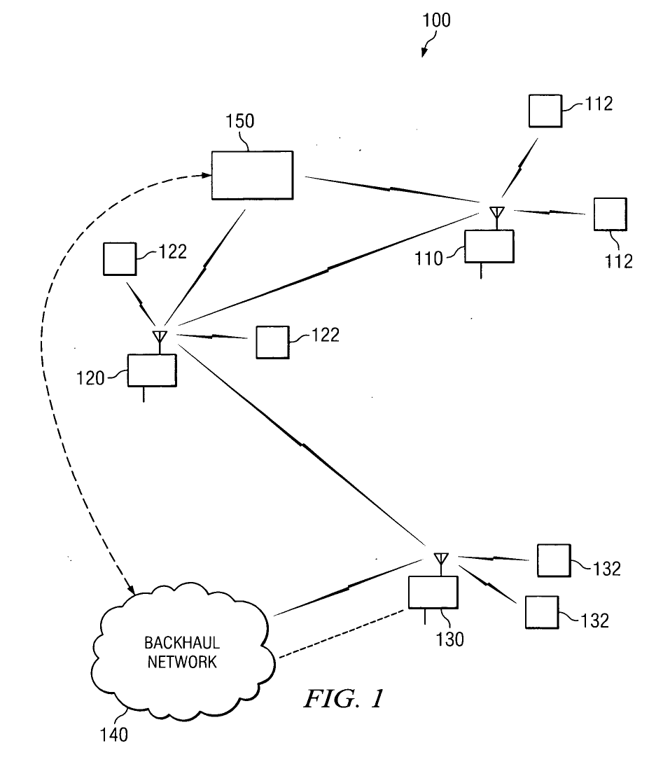

Referring to FIG. 1, there is shown a wireless network 100 in accordance with the present invention. The wireless network 100 includes a plurality of base stations 110, 120, 130, a backhaul network 140, and a telecommunications distribution point 150. Generally, the network 100 is similar to a traditional wireless cellular network with geographically separated base stations that each provide a point-to-multipoint architecture. Each base station 110, 120, 130 provides wireless communications services to one or more communication devices 112, 122, 132, respectively, as shown generally in FIG. 1. The coverage area (not shown) for each base station depends generally on the communication frequency (or frequencies), power, receiver sensitivity, geographic terrain, number of users, as well as other factors. The communications devices 112, 122, 132 transmit and receive wireless signals to/from the base stations 110, 120, 130, as shown.

The base stations 110, 120, 130 are communicatively coupled (backhauled) to a core or other telecommunications network (e.g., PSTN, internet, wireless, data, etc.). This may be accomplished via wireless or wireline communications paths from each base station 110, 120, 130 to the backhaul network 140 directly, or through one or more telecommunications distribution/access points 150, such as repeaters, relays, routers or other similar communications devices (not all possible communications paths or such devices are shown in FIG. 1, however the present invention contemplates any such possible devices and paths).

Communications between the base stations 110. 120, 120 and the backhaul network 140 (or through the distribution point 150) may be wireless or wireline, including RF, point-to-point microwave or conventional wire-line methods (including optical). Each base station 110, 120, 130 includes, generally all the functionality needed to transmit/receive wireless signals to/from the communications devices 112, 122, 132 and to further communicate with other communications devices in the network (e.g., other base stations, the backhaul network, distribution points, and any other devices in the network, as desired), such as, and including but not limited to antenna(s), transmitter(s), receiver(s), uplinks, downlinks, interfaces, power source(s) (battery, solar, AC/DC), necessary electronics, etc.

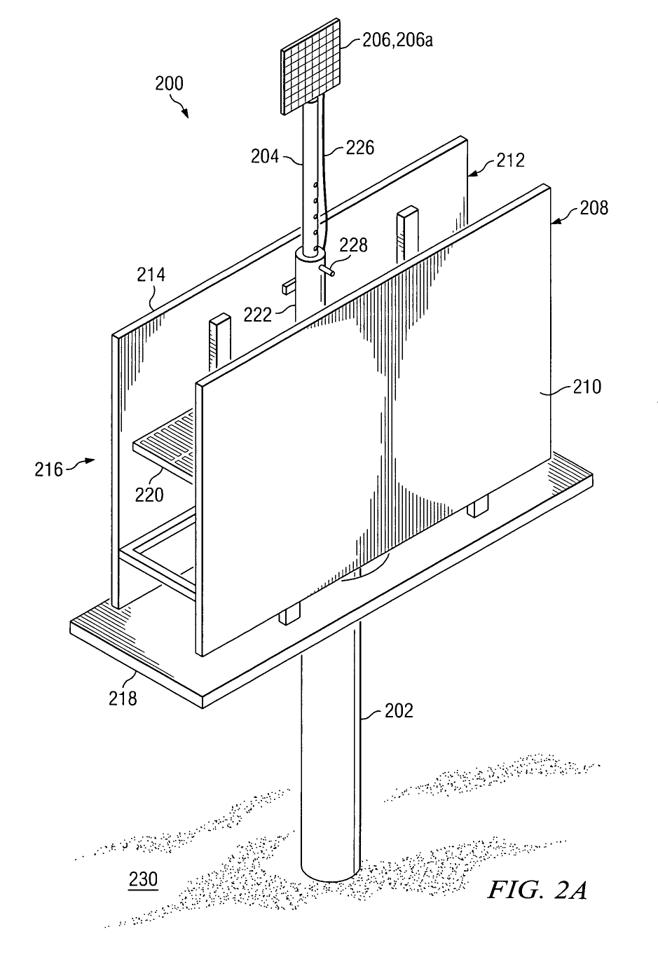

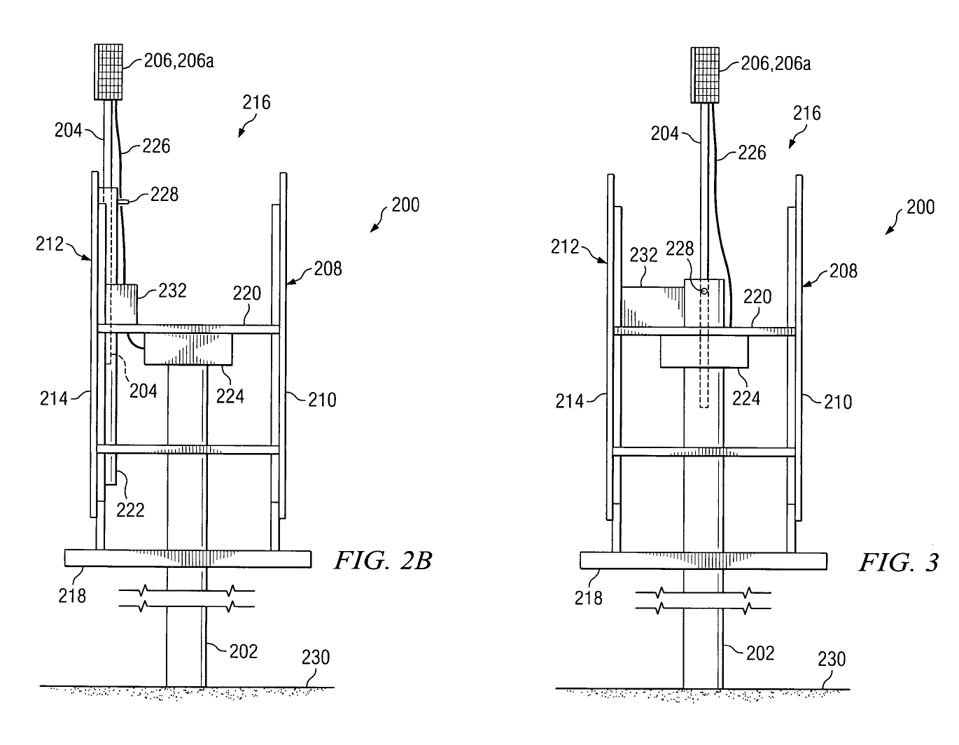

Now referring to FIGS. 2A and 2B, there are illustrated perspective and side views of an antenna mounting structure 200 for use with a base station. In general, the mounting structure 200 provides the structure to operably mount an antenna thereon for use by the base station within the network 100. As will be appreciated, the mounting structure 200 (and/or antenna 206) may be considered to be the base station, as a part of the base station, or separate from the base station.

The antenna mounting structure 200 includes at least one vertical support member 202, a first display member 208 having a first display surface area 210, a second display member 212 having a second display surface area 214, and a bracing and support structure 216 (or frame) mechanically coupled to the first and second display members 208, 212 and the vertical support member 202. The bracing and support structure 216 and support member 202 generally provide the structural support for the display members 208, 212 and the antenna elements. The support member 202 provides an anchor point with the ground (or reference point) 230.

In one embodiment, the surface areas 210, 212 of the display members 208, 212 are substantially flat or planar, and when the display members 208, 212 are on the structure 200, the surface areas are positioned (or oriented) substantially perpendicular to the ground plane (see the ground 230).

The bracing and support structure 216 may include multiple connection members (not individually shown) and one or more platforms or walkways, such as walkway 218 and rear walkway 220, and another support member 222 (as shown). While the structure 200 is shown with two display members 208, 212, the structure 200 may also be configured with only one display member or any number of such display members. Generally, the structure 200 is configured as, similar to, or is a conventional or typical outdoor advertisement billboard, road sign or message sign.

In accordance with the present invention, the mounting structure 200 includes an antenna support or extension member 204 (or mast) and an antenna 206. The antenna support member 204 is mechanically coupled to the structure 200 and is supported by the bracing and support structure 216 and/or the vertical support 202 (or other intermediate members). In the embodiment shown on FIG. 2B, the antenna support member 204 is coupled to the member 222, while the antenna 206 is coupled to the antenna support member 204. The antenna support member 204 functions to elevate the antenna to a level above the display members 208, 212. The vertical support member 202 and bracing and support structure 216 function to support and elevate the display members 208, 212, the bracing and support structure 216 and the antenna 206 (and support 204) above the ground level 230 (or other reference point).

In one embodiment (not shown), the antenna support member 204 (or mast) may be of a fixed length and rigidly coupled to any supporting member of the structure 200, thereby positioning the antenna 206 at a predetermined position/height. In another embodiment, the antenna support member 204 may be of variable length and secured in such manner to another member of the structure 200 to provide a selectively variable position/height for the antenna 206. In the embodiment shown, a telescoping or extending type mast member 204 and outer casing or guide 222 function to elevate the antenna 206 to a predetermined height above the display members 208, 212. In one embodiment, the inner diameter of the guide 222 is greater than the outer diameter of the mast member 204 (or vice versa). Generally, the guide or support member 222 is rigidly coupled to the structure 200, and the mast member 204 is secured to the member 222. This further provides a mechanism to raise and lower the antenna 206 (by extending or retracting the support 204) for maintenance or other purposes. Alternatively, the member 204 and guide member 222 may be a single unit constructed specifically to provide the desired functionality, which is secured to a member of the structure 200.

In another embodiment, as shown in FIG. 3, the member 204 may be coupled similarly to the main support 202 (used as the guide or support), or in other embodiments to some other support member (not shown).

The structure 200 includes an equipment box 224 and an electrical cable 226 connecting the equipment box 224 to the antenna 206. As will be appreciated, the equipment box 224 generally houses most of the electrical components of the base station, such as the receiver, transmitter, controller, etc. Alternatively, all or some of the equipment may reside on the ground or other point near the structure 200. The structure 200 further includes a means for raising and lower the antenna 206 (by raising and lowering the member 204). This may include a mechanical or electromechanical winch or other device 232 (shown by reference numeral 232), and may further include other mechanical elements to assist in providing this function. In another embodiment, the antenna 206, mast member 204 and/or support member 222 further include means for adjusting the angular positioning of the antenna 206. A pin or other mechanism 228 may also be implemented to secure the positioning of the antenna support member 204 (and antenna 206) once it is placed in the desired position.

The base stations 110, 120, 130 (as well as the communication devices 112, 122, 132 and any distribution or other access points in the network 100) of the present invention may operate in accordance with any communications protocols or standards. In one particular embodiment, the base stations function in accordance (compliant) with IEEE 802.16, and in another embodiment, with IEEE 802.20, and/or based upon WiMAX (Worldwide Interoperability for Microwave Access) technology. Thus, the frequencies of communications of the network 100 (communications between the base stations 110, 120, 130 and the communication devices 112, 122, 132) will range between 10 and 66 Ghz, and in one embodiment, the communications are non-line of sight in the sub 11 GHz frequency range. The communication devices 112, 122, 132 further include an antenna system, transceiver, processor and input/output devices (not shown), and may take the form of any wireless device (mobile or fixed), such as a computer, router, access/interface point (to other systems), PDA, phone, or other processing device including such functionality.

WiMAX technology is a standards-based (standard IEEE 802.16 and 802.20, and portions of 802.11) technology enabling the deliver of last mile wireless broadband access as an alternative to cable and DSL. WiMAX is intended to server multiple market segments including fixed and portable service applications. It provides up to thirty miles of service area range, allowing users to obtain broadband connectivity wirelessly without needing direct line of sight with a base station. Within a typical cell radius deployment of three to five miles, WiMAX Forum Certified systems can be expected to deliver shared throughput of up to 75 Mbps, sufficient bandwidth to support hundreds of businesses and with T1-type connectivity and individual users, such as residences or mobile users, with DSL-type or greater connectivity. Further, WiMAX technology is expected to be incorporated into notebook computers, PDAs and wireless hand-held devices in the next few years allowing urban areas and cities to become hot zones for outdoor broadband wireless access.

The antenna 206 may include a single antenna or array, but may also comprise multiple antennas or antenna arrays. The antenna 206 may mesh, segmented, directional or omnidirection, or other configurations and shapes may be used, as necessary to meet the desired performance characteristics. In one embodiment of the structure 200, the antenna 206 is positioned at the desired predetermined height above the display members 208, 212. In other embodiments, the antenna 206 is positioned at a height which is between about thirty, about fifty, or about fifty-five feet and one hundred feet above the ground level (or reference point) 230, or at a level less than or equal to about 100 feet above the ground level 230. Or, the overall height of the antenna mounting structure 200 is about one hundred feet or less, and further may be between about fifty feet and about one hundred feet in height. Use of a variable length support member 204 and a raising and lowering mechanism in accordance with the present invention allows the antenna 206 to be selectively positioned at a predetermined height and angular position.

Similar to the base stations, the antenna 206 of the present invention may operate in accordance with any communications protocols or standards. In one particular embodiment, the antenna functions in accordance (compliant) with IEEE 802.16, and in another embodiment, with IEEE 802.20, and/or based upon WiMAX technology.

In one embodiment, another antenna 206a is mounted on the structure 200 (not shown) of one or more of the base stations and may separate from or operate as a part or portion of the antenna 206, and may be at a different positional location from the antenna 206. The antenna 206a functions to receive and/or transmit wireless signals from/to another base station 110, 120, 130, the distribution point 150, and/or directly to the backhaul network 140. In another embodiment, the antenna 406a may further assist in providing the relay/repeater functionality as described below.

In another embodiment, one of more of the base stations 110, 120, 130 may not include the full functionality of a typical base station, but may operate more aptly as an extension or repeater for a base station. In such embodiment, the repeater/relay station will receive wireless signals from a base station and forward them to the communication device 112, 122, 132. Similarly, wireless signals received from the communication devices 112, 122, 132 (in the coverage area) are forwarded (wireline/wireless) to a base station.

With continued reference to FIGS. 2A and 2B, the display member 208 includes the display surface area 210 while the display member 212 includes the display surface area 214. Each of the surface areas 210, 214 is operable for displaying one or more visible (or pictorial) messages or advertisements, and during such operation, includes the visible message, advertisement, or image. Any dimensions and shape(s) for the surface areas 210, 214 may be utilized. In one embodiment, the area (and/or visible message or advertisement) of the surface areas 210, 214 may range from forty to one thousand square feet. In other embodiments, the area is about fifty square feet or greater, or about one hundred square feet or greater. In still other embodiments, the dimensional height of the areas (and/or visible message or advertisement) of the surface areas 210, 214 may be about five feet or greater, approximately ten feet, or about ten feet or greater.

The present invention combines a wireless transceiver with an antenna mounting structure in the form of a billboard (outdoor advertisement/message structure) or signboard, road sign, or other roadway or transportation path structure. In one embodiment, the inventors have determined that the billboard structure provides significant advantages to other structures as the antenna mounting structure and base/repeater station placement for the wireless network. This is because most conventional billboards already include (1) electrical power source availability, (2) strength and design characteristics sufficient to withstand wind and loading and that provide readily available attachment locations for the antenna systems, (3) numerous and desirous locations (along heavily traveled routes and high occupancy areas, will provide significant coverage areas), and (4) present availability with the need for expensive new infrastructure (such as new towers).

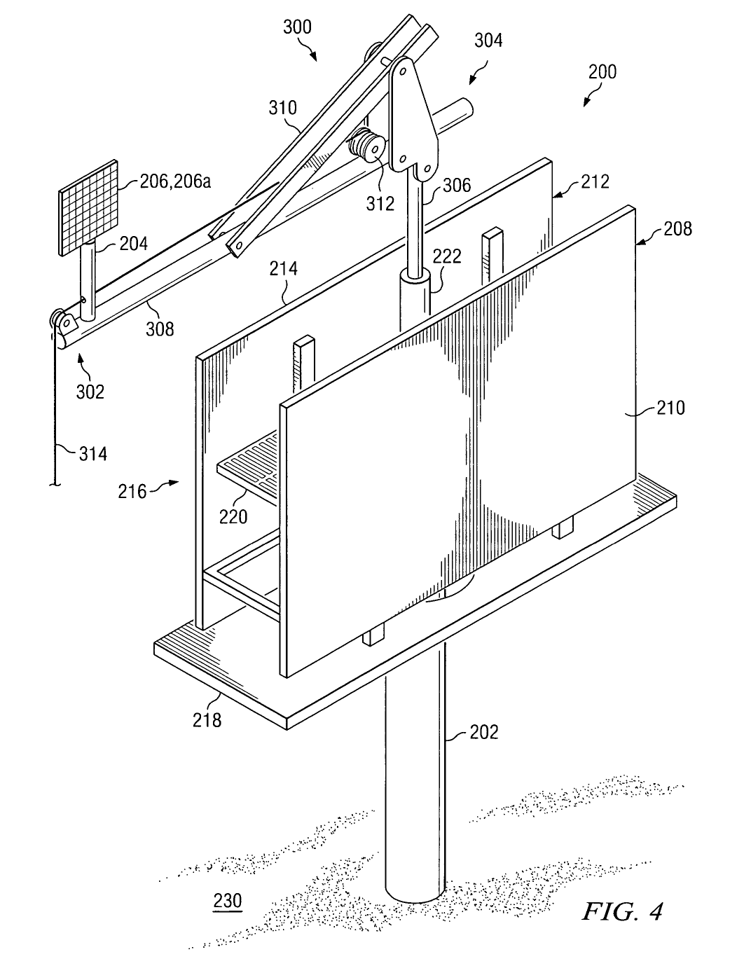

Now referring to FIG. 4, there is illustrated an antenna mounting structure 200 in accordance with another embodiment, as shown. The antenna mounting structure 200 includes an intermediate mounting device 300 coupled between the antenna 206 and one or more structural members of the structure 200. The intermediate mounting device 300 includes a distal end 302 and a proximal end 304. The device 300 includes a vertical mounting support member 306 mechanically and rigidly coupled to the frame 216 or member 202. Extending from the member 306 is an extension arm 308. One end of a horizontal member 310 is coupled to a top portion of the vertical mounting member 306 and the other end is coupled to the extension arm 308 at a point along the arm 308. As shown, the antenna 206 and antenna support 204 are mounted to the distal end 302 of the extension arm 308. Though the antenna 206 is shown mounted on the distal end of the arm 308, other mounting locations on the device 300 may be used, such as the proximal end 304 of the horizontal member 310.

The device 300 is shown in a deployed or extended position, but the device 300 is further operable to fold or store (undeployed) into a different and smaller configuration (not shown). The antenna 206 may be mounted thereon when the device 300 is either deployed or undeployed. The device 300 is also operable to rotate 360 degrees. In this embodiment, the device 300 supports and elevates the antenna 206 above the display members 208, 212.

The device 300 further includes a winch 312 and a cable 314 that allows the moving/raising/lowering of objects or material (such as louvers or facing material, or raising/lowering object to ground level). The winch 312 may be operated by hand (handcrank) or power tool (e.g., electric drill).

One particular device that may readily be utilized for the device 300 is known as a “JIB Pole” and is available from Formetco, Inc.

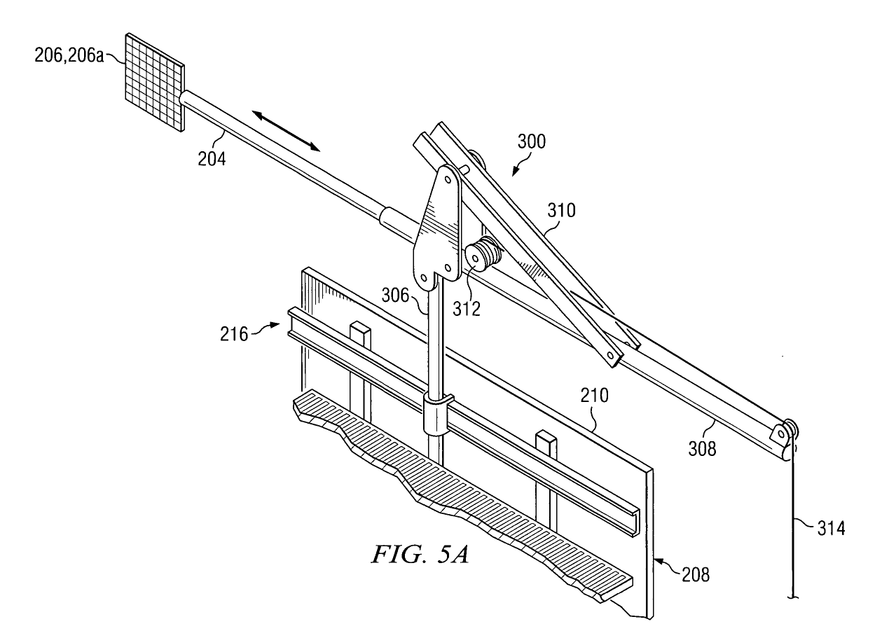

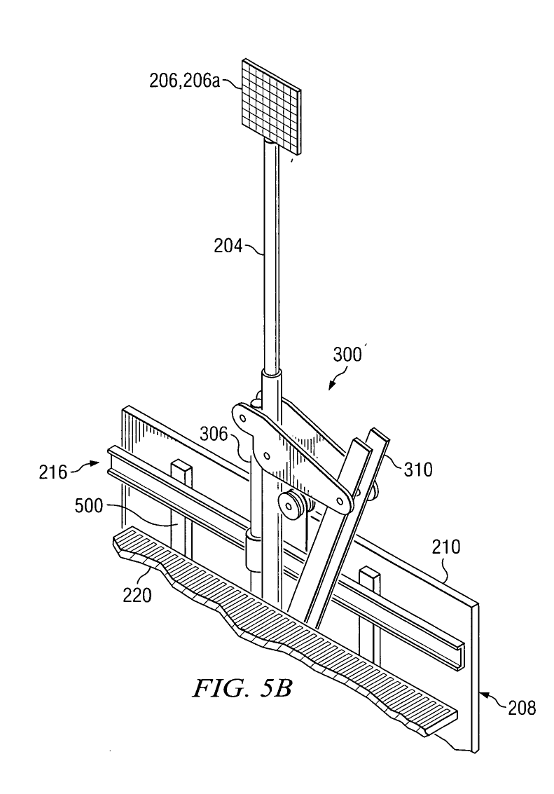

Now referring to FIGS. 5A and 5B, there are shown partial views of an alternative configuration for the connection of the antenna 204 to the device 300. The antenna support member 204 is coupled to the extension arm 308 such that the member 204 may be extended or retracted from the extension arm 308, such as a telescoping function. In such manner, the extension arm 308 may be used in a similar fashion as the guide 222 (described above).

FIG. 5A illustrates the device 300 in a first position (deployed or extended), with the antenna support member 204 (and antenna 206) mounted at, and extending from, the proximal end 304 of the device 300. In this position, the device 300 may operate for other functions/purposes, such as raising/lower objects and material and activities related to the structure 200 (repair, maintenance, modification, such as modifying or changing the image on the display member 208).

FIG. 5B illustrates the device 300 in a second position (undeployed, retracted, or stored position), with the member 204 (and antenna 206) extending vertically above the display member 208. This illustrates the typical configuration when the antenna 206 is extended/deployed and the base station is in operation. As shown, the device 300 is folded down into the second position between the walkway 220 and a main vertical support member 500 of the structure 200. In this position, the antenna support member 204 (and antenna 206) may be raised and lowered to the desired location. This may be accomplished by any means or mechanism, such as a winch or other device (not shown), incorporated therein. Also, this means/mechanism may be readily present by virtue of the telescoping configuration of the members (may be raised/lowered by hand, if feasible), or by some other mechanism readily known by those skilled in the art.

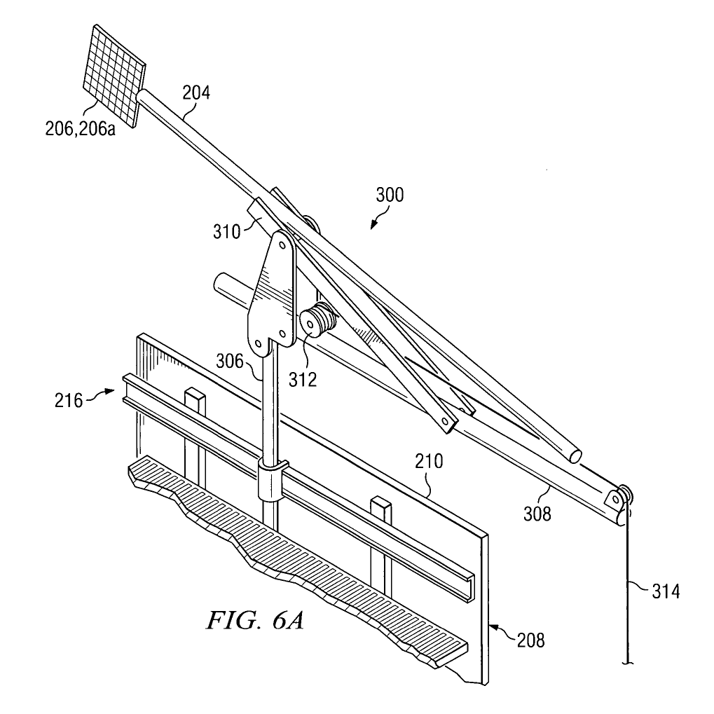

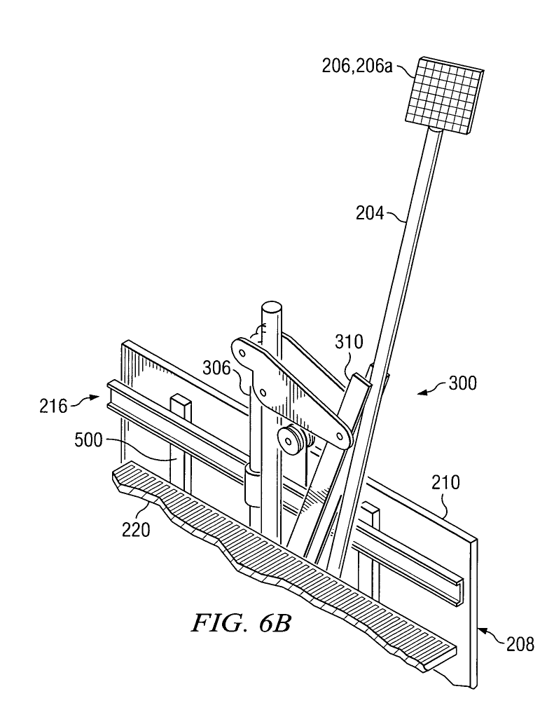

Now referring to FIGS. 6A and 6B, there are shown partial views of yet another alternative configuration for the connection of the antenna 204 to the device 300. The antenna support member 204 (either a fixed length member or variable length member with a guide member and a mast member such as a telescoping device) is coupled to and extends along the extension arm 308 and/or horizontal member 310. The member 204 is coupled thereto using a number of connections at the appropriate locations.

FIG. 6A illustrates the device 300 in a first position (deployed or extended), with the antenna support member 204 (and antenna 206) mounted to the device 300, and extending from the proximal end 304 of the device 300. In this position, the device 300 may similarly operate for other functions/purposes (as described above).

FIG. 6B illustrates the device 300 in a second position (undeployed, retracted, or stored position), with the member 204 (and antenna 206) extending vertically above the display member 208. This illustrates the typical configuration when the antenna 206 is extended/deployed and the base station is in operation. As shown, the device 300 is folded down into the second position between the walkway 220 and the main vertical support member 500 of the structure 200. In this position, the antenna support member 204 (and antenna 206) may be raised and lowered to the desired location, if the member 204 is constructed to perform an extending/retracting function. This may be accomplished by any means or mechanism, such as a winch or other device (not shown), or as described above.

Each base station 110, 120, 130 is located in a specific geographic location and provides a network access point for the communications devices 112, 122, 132 in the respective coverage area of the respective base station. Each base station 110, 120, 130 may further communicate with other devices in the network 100 (such as the distribution node 150, devices in the backhaul network 140, or other devices).

In general operation, a communications device 112, 122, 132 communicates with one or more other communication devices through various aspects of the network 100 (to devices located within the network 100, network 140 or other telecom network). The communications device 112, 122, 132 generates and transmits data to a desired destination by communicatively coupling to the respective base station 110, 120, 130. The base station than transmits the received data through a communication path (which may involve several other nodes) to the desired destination. In the reverse direction, data is received at the communications device 112, 122, 132 via the respective base station 110, 120, 130.

In one embodiment, the base station may be located in a remote geographical area that does not provide the capability of accessing a wireline communication path. In this case, the base station re-transmits data received from its local communications device wirelessly to another base station or other device (at a different location) within the network, which is then forwarded to the desired destination point.

Substantially contemporaneously with the reception and/or transmission of communications signals from the antenna 206 mounted on the structure 200, the display member 208 of the structure 200 visibly displays an image, message or advertisement, as described herein.

As will be appreciated, in another embodiment, communication signals wirelessly received from one or more communications devices (112, 122, 132, 140, 150) may be used to control one or more aspects of the image displayed on the display member 208, 212. In yet another embodiment, the display member 208, 212 may comprise an LED display or other type of electronic display.

In one embodiment, the communication devices communicating with the base station may be located up to thirty miles from the base station (antenna mounting structure), and in another embodiment the communications devices may be located at least about five miles from the base station (antenna mounting structure).

Though described as a “base station”, one or more of the stations 110, 120, 130 may not include the full functionality of a conventional base station, and may operate functionally as a repeater/relay/access station for the appropriate communications device. These types of stations are communicatively coupled to a base station or centralized distribution point. Such communication may be wireline or wireless, however, as described previously, wireless communication may be more appropriate.

The present invention provides for the fast and relatively inexpensive deployment of a wireless broadband network covering a significant area by using existing structures (billboards, transportation signage structures or other existing structures) as bases stations with little modification or new construction.

It may be advantageous to set forth definitions of certain words and phrases that may be used within this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and if the term “controller” is utilized herein, it means any device, system or part thereof that controls at least one operation, such a device may be implemented in hardware, firmware or software, or some combination of at least two of the same. It should be noted that the functionality associated with any particular controller may be centralized or distributed, whether locally or remotely. The term “couple” or “connect” refers to any direct or indirect connection between two or more components, unless specifically noted that a direct coupling or direct connection is present.

Although the present invention and its advantages have been described in the foregoing detailed description and illustrated in the accompanying drawings, it will be understood by those skilled in the art that the invention is not limited to the embodiment(s) disclosed but is capable of numerous rearrangements, substitutions and modifications without departing from the spirit and scope of the invention as defined by the appended claims.

1. An antenna mounting structure for a base station at a first location in a wireless network, the structure comprising:
a structural member;
a first display member having a first display surface, the first display surface including a first visible message placed thereon; and
an antenna operable for receiving and transmitting wireless communications signals from a wireless communication device at a second location.

2. The structure in accordance with claim 1 wherein the structure is a billboard structure, and the first display surface having the first visible message thereon has an area greater than forty square feet.

3. The structure in accordance with claim 1 further comprising:
a second display member having a second display surface, the second display surface including a second visible message placed thereon.

4. The structure in accordance with claim 3 wherein the structure is a billboard structure, the first display surface having the first visible message thereon has an area greater than forty square feet, and the second display surface having the second visible message thereon has an area greater than forty square feet.

5. The structure in accordance with claim 1 wherein the antenna receives and transmits communications signals in accordance with a WiMAX standard.

6. The structure in accordance with claim 1 wherein the antenna is operable for receiving and transmitting communications signals in the range of 9 to 44 Gigahertz.

7. The structure in accordance with claim 1 further comprising:
an antenna support member coupled to the structural member and having an elongate mast member and an elongate guide member, wherein the antenna is connected to the mast member, and wherein the mast member is movable with respect to the guide member thereby operably positioning the antenna at a predetermined position.

8. The structure in accordance with claim 7 wherein the antenna is positioned at a height between about fifty and about one hundred feet above a ground level.

9. The structure in accordance with claim 8 wherein the antenna is positioned above the first display member.

10. The structure in accordance with claim 1 further comprising:
means, coupled to the structural member, for raising and lowering an object, wherein the antenna is mounted on the means for raising and lowering at a height above the first display member.

11. A base station in a wireless network, the base station comprising:
an elevated frame structure, comprising,
at least one vertically extending support member, and a bracing and support structure connected to the vertically extending support member;
a first display member connected to the bracing and support structure, the first display member having a first display surface, the first display surface including a visible message placed thereon;
an antenna support member coupled to the elevated frame, the antenna support member comprising a guide member and a mast member having a distal end and a proximal end, wherein the distal end of the mast member extends upwardly and is movable from a first position to a second position relative to the guide member;
an antenna connected to the distal end of the mast member, wherein the antenna is positioned at a first height when the mast member is in the first position and at a second height when the mast member is in the second position, and wherein second height is above the first display member, and wherein the antenna is further operable for receiving and transmitting wireless communications signals from a wireless communication device at a remote location; and
electronic circuitry coupled to the antenna for processing wireless communications signals.

12. The structure in accordance with claim 11 wherein the antenna receives and transmits communications signals in accordance with a WiMAX standard.

13. The structure in accordance with claim 12 wherein the antenna is operable for receiving and transmitting communications signals in the range of 9 to 44 Gigahertz.

14. The structure in accordance with claim 11 wherein the antenna support member further comprises:
means for raising and lowering an object relative to the elevated frame structure, the means further configured to deploy and extend into a first position thereby allowing the raising and lowering of an object and fold and contract into a second position.

15. The structure in accordance with claim 11 wherein the second height of the antenna is between about thirty and about one hundred feet above a ground level.

16. An outdoor advertisement structure comprising:
a structural member for supporting one or more other members;
a first display member mounted to the structural member, the first display member having a first surface, the first surface having an image thereon encompassing about forty square feet or greater;
an antenna mounted to the structural member at a height above the first display member, the antenna further operable for receiving and transmitting wireless communications signals from a wireless communication device at another location; and
electronic circuitry coupled to the antenna for processing wireless communications signals.

17. The structure in accordance with claim 16 wherein the structure is a billboard structure, and the first display surface having the first visible message thereon has an area greater than forty square feet.

18. The structure in accordance with claim 16 wherein the antenna and electronic circuitry are operable for receiving and transmitting communications signals in range of 9 and 44 Gigahertz and in accordance with one or more WiMAX standards.

19. The structure in accordance with claim 18 further comprising:
an antenna support member mounted to the structural member and having an elongate mast member and an elongate guide member, wherein the antenna is connected to the mast member, and wherein the mast member is movable with respect to the guide member thereby operably positioning the antenna at a predetermined position.

20. The structure in accordance with claim 7 wherein the antenna is positioned at the height between about fifty and about one hundred feet above a ground level.

21-22. (canceled)
